(19) United States
(12) Patent Application Publication
(10) Pub. No.: US 2004/0098839 A1
(43) Pub. Date: May 27, 2004

(54) Crystallization method and apparatus using an impinging plate assembly

(75) Inventors: Steven J. Brenek, New London, CT (US); David J. Am Ende, Waterford, CT (US)

Correspondence Address: PFIZER INC., PATENT DEPARTMENT, MS8260-1611, EASTERN POINT ROAD, GROTON, CT, 06340, US

(73) Assignee: Pfizer Inc.

(21) Appl. No.: 10/714,429

(22) Filed: Nov. 13, 2003

Related U.S. Application Data
(60) Provisional application No. 60/429,643, filed on Nov. 27, 2002.

(51) Int. Cl. B01D 9/00

(52) U.S. Cl. 23/295 R; 546/184; 562/400

(57) ABSTRACT

A crystallization process for generating a pharmaceutical product from solutions of pharmaceutically active compounds or their reactive intermediates employs fluid jet streams containing pharmaceutically active ingredients, appropriate anti-solvents and/or their reactive intermediates capable of producing a pharmaceutical product with desired particle size characteristics upon mixing, chemical reaction, nucleation and precipitation. The jet streams are directed towards an impinging plate, and mixing occurs as the jet streams impinge the plate at a desired area of impact.

### CROSS REFERENCE TO RELATED APPLICATION

This application claims the benefit of U.S. Provisional Application No. 60/429,643 filed Nov. 27, 2002.

### FIELD OF THE INVENTION

The present invention relates in general to the preparation of pharmaceutical products and compounds, and in particular, to a method and apparatus for generating a pharmaceutical product having small crystals of controlled particle size and structure.

### BACKGROUND OF THE INVENTION

In the pharmaceutical industry, crystallization processes are common for generating a pharmaceutical product from solutions of pharmaceutically active compounds or their reactive intermediates. The use of an impinging jet device in a crystallization process to achieve micromixing of the solutions is known in the art. For example, EP 1,157,726 A1 and U.S. Pat. No. 5,314,506, both incorporated herein by reference, provide methods of impinging two or more fluid jet streams of solutions in a continuous crystallization process to achieve high intensity micromixing of fluids so as to form a homogenous composition prior to the start of nucleation. The jet streams are directly impinged to create high turbulence at the point of impact under conditions of temperature and pressure that permit micromixing of the solutions. Each of these methods generally comprises two substantially diametrically opposed jets providing jet streams that impinge to create an immediate high turbulence impact.

One standard crystallization process involves mixing a supersaturated solution of the compound to be crystallized with an appropriate “anti-solvent” or crystallizing agent. Another standard crystallization process employs temperature variation of a solution of the compound to be crystallized in order to bring the solution to its supersaturation point. In U.S. Pat. No. 5,314,506, impinging jets are utilized in combination with these standard crystallization processes to generate a crystallized compound. Nucleation and precipitation are initiated after micromixing by utilizing the effect of temperature reduction on the solubility of the compound to be crystallized in a particular solvent, or by taking advantage of the solubility characteristics of the compound in solvent mixtures, or by some combination of the two techniques.

In EP 1,157,726 A1, assigned to the applicant of the present invention, impinging jets are used to achieve high intensity micromixing of two liquid streams containing chemical reactants. After mixing of the two liquid streams, a chemical reaction occurs, forming a reaction product under high supersaturation conditions that then lead to rapid nucleation. This continuous reaction and crystallization process increased the utility of the opposed impinging jet design in the formation of pharmaceutical products from solutions of chemical reactants.

With the known opposed impinging jet methods it is possible to prepare crystal products with particles sized between 5 to 1000 microns. The processes permit direct crystallization of the high surface area particles of high purity and stability. Particle size is controlled by varying the concentration and temperature of the solutions, as well as the velocity of the solutions through the jets.

Disadvantages of the opposed impinging jet design result from the positioning and alignment of the jet nozzles. The desired positioning of the jet nozzles, when two jet streams are used, is at or close to a 180 degree angle to one another from an overhead view. Further, the jet nozzles must be perfectly aligned so as to maximize the impingement between the jet streams. As so positioned and aligned, the point of impact must be between the jet nozzles, and generally is a specifically defined and limited three-dimensional space between the jet nozzles allowing relatively small room for error. Errors typically occur where the alignment between the jet nozzles if off in one or more of the x-, y- and z-directions, or where the flow rate of one or both of the jet streams is too low or too high.

In the opposed impinging jet design, the jet nozzles are downwardly disposed to facilitate feed of the solutions through the nozzles, but further to limit contamination and damage to the jet nozzles that may result if the fluid of one stream enters or splatters into the outlet hole of the opposite nozzle, possible causing crystallization and clogging in the jet nozzle.

Precise control of the flow rates is also necessary to position the point of impact at a location where complete micromixing, reaction and nucleation will occur. Precipitation of the solutions generally used with such crystallization processes generally occurs quickly. In order to create a homogenous mixture, the solutions must interact prior to nucleation. Overflow or underflow of even one of the solutions will affect the mixture to the extent that only portions of the solutions will interact before nucleation. As a result, the mixture will not exhibit the desired homogeneity. Thus, insufficient flow rates from one or more of the jet nozzles may affect the quality of the entire batch being produced, especially if a majority of the solutions are not micromixed at the desired point of impact. Generally, the preferred flow for the impinging jet streams has little room for variance. Positioning the point of impact at a location too close to one of the jet nozzles may also result in contamination and damage to the jet nozzle due to splatter of solution into the outlet of the jet nozzle.

EP 1,157,726 A1 further describes the use of an impinging jet device with a sonication probe to achieve high intensity mixing coupled with a chemical reaction to provide a new chemical compound of controlled particle size of crystalline materials. WO 00/44468, incorporated herein by reference, also describes an apparatus and process for crystallizing submicron-sized particles with the introduction of a sonication probe with impinging jets for use with non-reactive precipitation.

### SUMMARY OF THE INVENTION

The present invention provides a method and apparatus for preparation and crystallization of pharmaceutical compounds or their intermediates which directly produce high surface area end product crystals with greater stability, purity and homogeneity without the need for subsequent high intensity milling to meet bioavailability requirements. By removing the need for milling, the present invention avoids the associated problems of noise and dusting, cuts yield loss, and saves the extra time and expense incurred during milling, as well as eliminating the opportunity for adverse effects on labile compounds. Eliminating the milling step also removes the need for personnel contact with the compounds, generally a highly potent pharmaceutical agent.

The small particle size and structure attained with the opposed impinging jet design and process may be attained with the method and apparatus of the present invention. Thus, the present invention can attain a small particle size that is consistent within a single run and reproducible between runs. Additionally, the pure, high surface area particles that result from the method of the present invention display superior crystal structure when compared to particles formed via standard slow crystallization plus milling methods, and even some of the opposed impinging jet methods, when using the same quality and kind of solutions. Improvements in crystal structure result in slower rates of decomposition and therefore longer shelf life for the crystallized product or a pharmaceutical composition containing the crystallized material.

In a first aspect of the present invention, a crystal production apparatus comprises an impinging plate having an impact area defined on a surface thereof, and at least two jet nozzles adapted to direct respective jet streams towards the impinging plate so that said jet streams impinge the impact area of the impinging plate.

In another aspect of the present invention, a process for synthesis and crystallization of a pharmaceutical product includes impinging at least one jet stream of a first fluid on an impact area defined on a surface of an impinging plate, and impinging at least one jet stream of a second fluid on the impact area. The at least one jet stream of the first fluid is mixed with the at least one jet stream of the second fluid about the vicinity of the impact area upon impingement of the jet streams with the impinging plate. Each jet stream is provided with sufficient linear velocity to achieve high intensity mixing of said fluids, followed by nucleation of the pharmaceutical product and production of small crystals of controlled particle size.

In the present invention, the first fluid can include a first reactive intermediate and the second fluid can include a second reactive intermediate, where the respective reactive intermediates undergo a reaction after mixing, followed by nucleation of the pharmaceutical product. Alternatively, the first fluid can include an active pharmaceutical ingredient (e.g., a feed solution of a compound to be crystallized in a suitable solvent or combination of solvents), and the second fluid can include an appropriate anti-solvent, where the feed solution and the anti-solvent undergo a non-reactive mode of mixing, followed by nucleation of the pharmaceutical product. Further, the first and second fluids can both be solutions of a compound to be crystallized in the same solvent or combination of solvents, where nucleation and precipitation are initiated after mixing of the fluids.

The present invention also provides advantages over the opposed impinging jet method and design of the prior art. Specifically, the jet nozzles of the present invention are easier to align and permit more robust flow rates. As a result the present invention is easier to employ. For example, the jet streams preferably intersect simultaneously with their impingement with the plate. The position of the plate is maintained, so misalignment between the jet streams only requires adjustment in the x- and y-directions. In the opposed impinging jet design, adjustment is often needed in the x-, y- and z-directions if the jet streams are misaligned.

Also, the plate of the present invention aids the mixing process. If the flow rates are properly controlled, the jet streams will form liquid films on the plate's surface after impingement due to surface tension effects. As the liquid film for each respective jet stream spreads out on the plate, the liquid films mix, nucleate and precipitate to form the desired compound. Where appropriate, the mixing of the liquid films causes reactive intermediates in the fluids to react, or an anti-solvent in one fluid to interact with a feed solution in the other fluid, prior to nucleation.

Further, while precise control of the flow rates ensures optimum results in both the present invention and the opposed impinging jet design, the present invention permits greater variation of operating factors without compromising the desired homogeneity of the mixing process. For example, the flow rates of the jet streams can be varied without significantly affecting the resultant product. That is, the flow rates can be increased or decreased from the ranges typically used in the opposed impinging jet method while ensuring sufficient and homogenous micromixing of the entire jet streams. Thus, the present invention is not as constrained by the need for a high velocity flow rate as is necessary for the opposed impinging jet design. The positioning and alignment of the jet nozzles can also be varied from run to run, depending on the composition of the fluids being mixed and corresponding flow rates used therefor. Also, more than two jet nozzles and jet streams can be used. The impinging plate of the present invention can also have various forms and shapes depending on the fluids and flow rates used.

According to a preferred aspect of the invention, the pharmaceutical product is voriconazole, (2R,3S)-2-(2,4-difluorophenyl)-3-(5-fluoro-4-pyrimidinyl)-1-(1H-1,2,4-triazol-1-yl)-butan-2-ol, having the following structure:

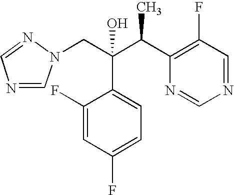

Voriconazole is disclosed in U.S. Pat. No. 5,567,817 and U.S. Pat. No. 5,773,443 (both of which are incorporated herein by reference); and is useful in the treatment of fungal infections.

### BRIEF DESCRIPTION OF THE DRAWINGS

Embodiments of the present invention have been provided for purposes of illustration and description, and are shown in the accompanying drawings forming a part of the specification wherein:

FIG. 1 is a schematic diagram showing a crystal production system in accordance with the present invention.

FIG. 2 is a front view of an impinging plate assembly used in the crystal production system of FIG. 1.

FIG. 3 is a side view of the impinging plate assembly of FIG. 2.

FIG. 4 is a bottom view of the impinging plate assembly of FIG. 2.

FIG. 5 is a front view of a crystallization chamber including an impinging plate assembly in a horizontal orientation.

FIG. 6 is a front view of a crystallization chamber including an impinging plate assembly in an angled orientation.

FIGS. 7a-7e are normal views of the impinging plate illustrating various positions of jet nozzles that may be used with the impinging plate assembly of the present invention.

FIGS. 8a and 8b are front views illustrating alternative positions of the jet nozzles, namely staggered jet nozzles (FIG. 8a) and concentric or coaxial jet nozzles (FIG. 8b), that may be used with the impinging plate assembly of the present invention.

FIGS. 9a-9j illustrate various impinging plate designs that may be used for the impinging plate assembly of the present invention. In particular, FIGS. 9a-9e illustrate vertical cross-sectional views of impinging plate designs, FIGS. 9f-9g illustrate horizontal cross-sectional views of impinging plate designs, FIG. 9h illustrates a perspective view of an impinging plate design, and FIGS. 9i-9j illustrate normal views of impinging plate designs.

### DETAILED DESCRIPTION OF THE DRAWINGS

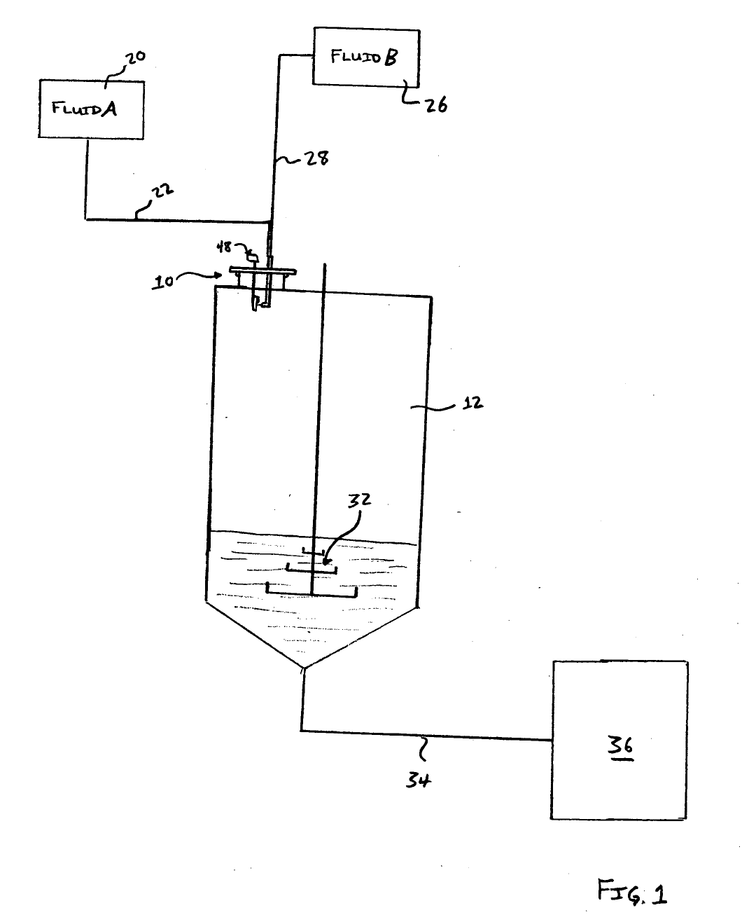

The present invention involves the use of jet nozzles to create fluid jet streams that impinge against a plate having a flat, curved or otherwise angled surface, and thereby achieve high intensity micromixing and/or reaction of the fluids prior to nucleation in a crystallization process to produced a crystallized pharmaceutical product. FIGS. 1-4 show a crystal production system incorporating an impinging plate assembly, generally designated by reference numeral 10, and a crystallization chamber 12 where the micromixing of the fluids occurs. The impinging plate assembly 10 is shown more closely in FIGS. 2-4. In the embodiment shown, first and second fluids A and B are fed to first and second jet nozzles 14 and 16 disposed within the chamber 12. The first fluid A is supplied through a nozzle 18 of the first jet nozzle 14 from a first supply source 20 by means of a suitable first product feed line 22. The second fluid B is similarly supplied through a nozzle 24 of the second jet nozzle 16 from a second supply source 26 by means of a suitable second product feed line 28. The nozzles 18 and 24 are directed towards an impinging plate 30 also disposed within the chamber 12 so that the respective jet streams impinge the plate 30 to effect mixing of the fluids A and B. Though two jet nozzles are shown to micromix two fluids, the present invention can be used to accommodate more than two jet streams to micromix multiple fluids.

Micromixing, nucleation and precipitation, and where appropriate reaction, of the fluids A and B preferably occurs within the chamber 12, with the crystallized product collecting in the bottom of the chamber 12. Preferably, the chamber 12 is cylindrical in shape and has a floor that slopes downward in a conical or dome shape towards the floor's center. The chamber 12 may include means for stirring or agitating the collected product, generally designated in FIG. 1 by reference numeral 32. The crystallized product can be discharged from the chamber 12 through an opening in the conical floor into another container for further processing of the crystallized product (e.g., stirring or agitation) or for filtration of the product. As shown in FIG. 1, the crystallized product is discharged from the bottom of the chamber 12 through a discharge conduit 34 to a filter 36. The diameter and cylinder wall height of the chamber 12 can vary according to scale and batch needs.

As shown in FIGS. 2-4, the impinging plate assembly 10 comprises the impinging plate 30 and the first and second jet nozzles 14 and 16 suspended from and supported by a horizontal support member 38. The horizontal support member 38 may act as a flange, attachable to the chamber 12 after the impinging plate assembly 10 is inserted and positioned therein. The chamber 12 may be sealed, or alternatively vented, to facilitate control of the crystallization process with respect to flow rates, temperature and mixture purity. While the crystallization process is underway, exterior contaminants could be prevented from entering the chamber 12, and likewise, the jet streams and the crystallized product created would be retained within the chamber during the processing run. A sealed chamber permits accurate control of the environment within the chamber. For example, the interior temperature may be controlled so as to aid reaction, nucleation and precipitation of the fluids. Outside particles or conditions that may influence the homogeneity or purity of the mixture can be eliminated.

The impinging plate assembly 10 may be positioned within the chamber 12 in various orientations, using different structural designs, including through an opening provided in the side of the chamber, as shown, for example, in FIG. 5. The specific embodiments shown in the drawings—e.g., FIGS. 1, 5 and 6—are provided for illustration, and the present invention is not limited to those specific embodiments, and in particular the precise support structures shown.

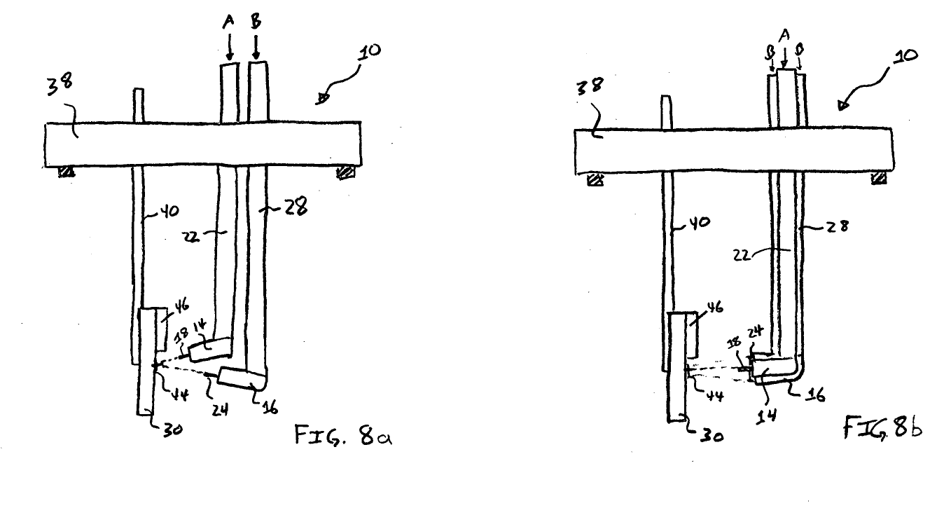

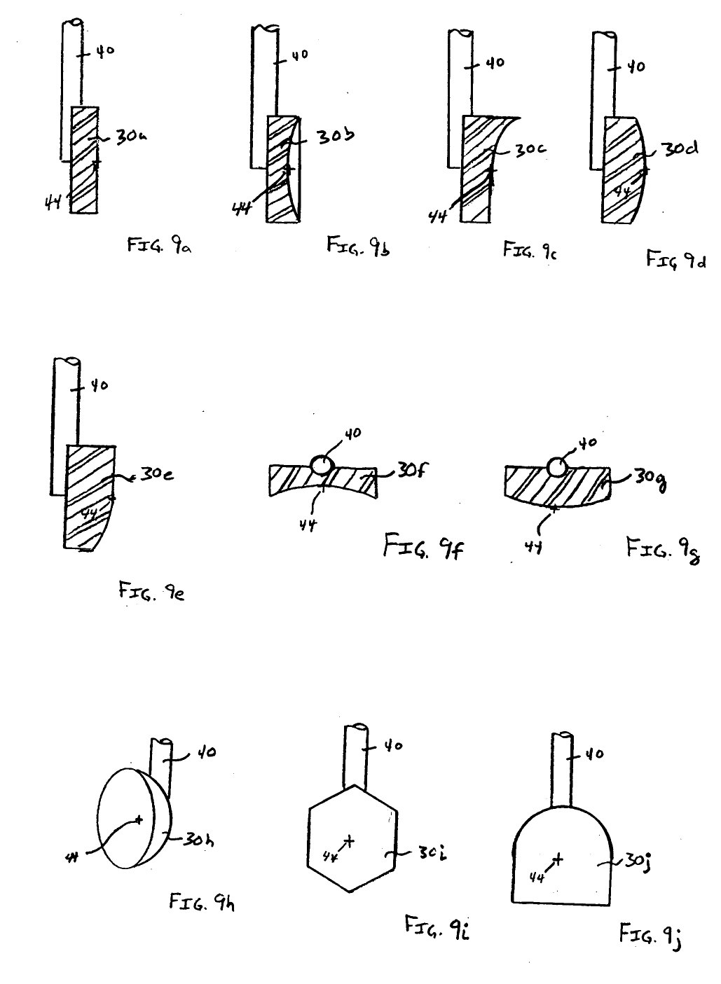

In the vertical orientation of FIG. 2, the first and second feed lines 22 and 28 extend through the horizontal support member 38 to supply the respective fluids A and B to the first and second jet nozzles 14 and 16. The plate 30 is suspended from and supported by the horizontal support member 38 within the chamber 12 by way of a vertical support member 40 connected to the horizontal support member 38. The connection between the horizontal support member 38 and the vertical support member 40 is preferably adjustable so as to permit adjustment of the vertical, horizontal and angular positions of the plate 30 within the chamber 12. Further, the horizontal support member 38 and the vertical support member 40 may be designed so as to permit removal of the plate 30 for cleaning, repair, repositioning or replacement, even if the horizontal support member 38 is secured to the chamber 12. For example, the plate 30 may be adjustably received by and removable from the vertical support member 40. A hatch or opening could be provided in the horizontal support member 38 to permit the operator to remove the plate 30 from the vertical support member 40, and position a new plate thereon, or alternatively, for example, the operator may adjust the angular position of the plate 30 on the vertical support member 40 (as shown, in part, in FIG. 6). The interchangeability of plates on the impinging plate assembly 10 is advantageous because plates of varying design may be used depending on the fluids being mixed, the flow rates being used, or other environmental properties that may vary for different product batches (see FIGS. 9a-9j).

Similarly, the positioning and alignment of the first and second jet nozzles 14 and 16 within the chamber 12 can be adjustable. However, once the positions and alignment of the jet nozzles 14 and 16 have been set, the positions and alignment should preferably be maintained during operation. Thus, the portion of the feed lines 22 and 28 extending into the chamber 12 should preferably maintain at least the jet nozzle tips 18 and 24 in stable positions with respect to the plate 30. The feed lines 22 and 28 may further be stabilized by cross members 42 connecting the feed lines 22 and 28 to the vertical support member 40, though such cross members 42 are not needed if the feed lines are sufficiently self-stabilizing. Preferably, the user should be able to adjust the vertical position of each jet nozzle, the horizontal position of the jet nozzles with respect to the plate, the distance between the jet nozzles, and the angular position of the jet nozzles with respect to the plate, horizontally, vertically, or both. Thus, the cross members 42 should be designed so as to permit such adjustments, while stabilizing the feed lines after the adjustments have been made.

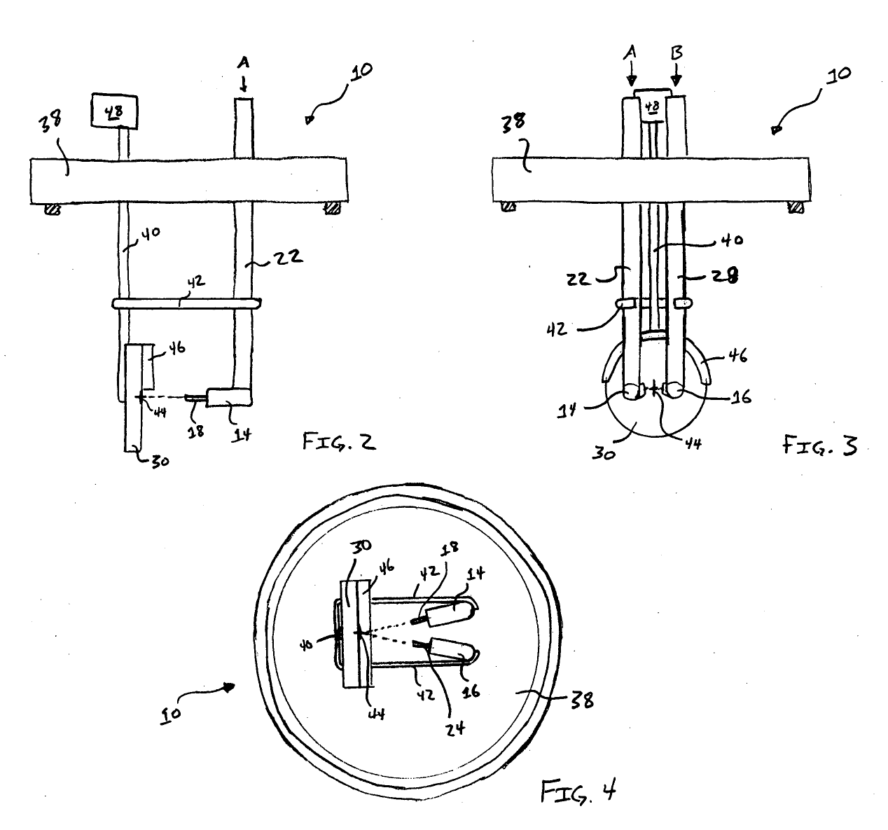

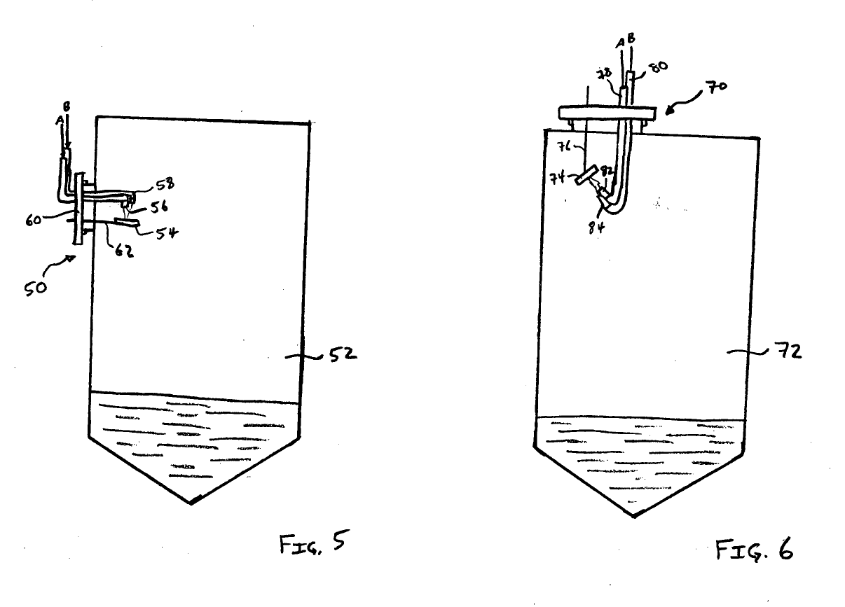

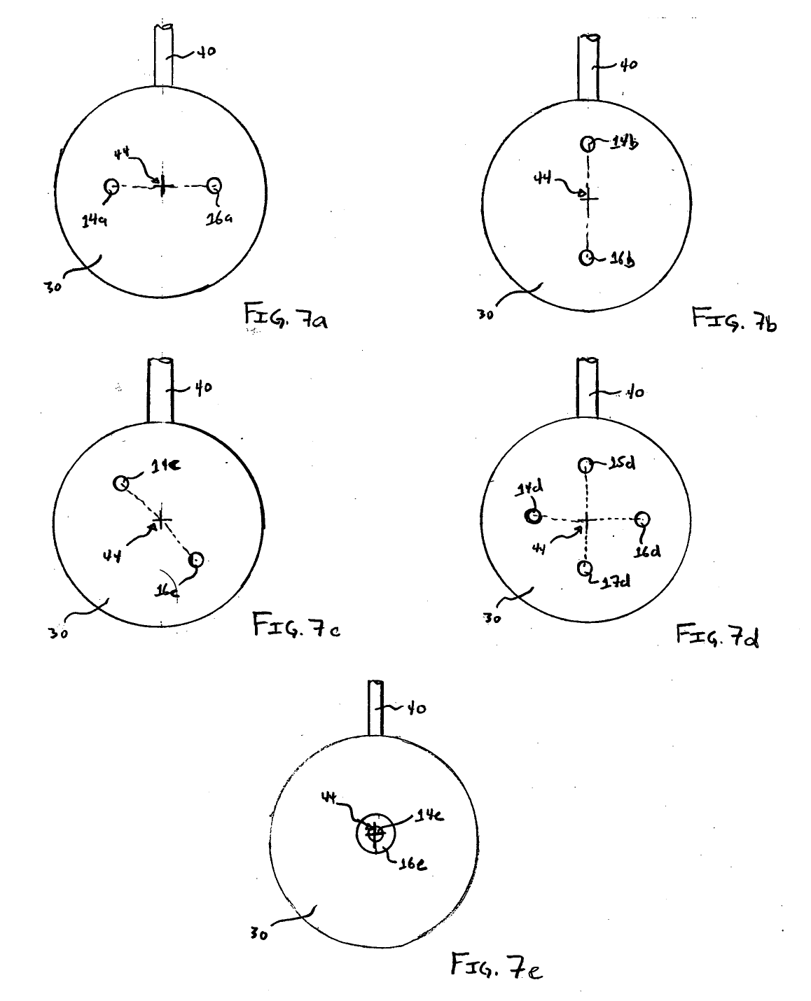

Preferably, the jet nozzles 14 and 16 are positioned the same distance from the plate 30, as shown in FIG. 4. However, the jet nozzles 14 and 16 may be staggered at different distances from the plate 30, as shown, for example, in FIG. 8a. Similarly, the jet nozzles may be positioned at different vertical positions, for example, one on top of the other, or in a diagonal arrangement. If more than two jet nozzles are used, the jet nozzles may be arranged in a variety of patterns. A variety of jet nozzle arrangements for use with the present invention are illustrated in FIGS. 7a-7e. Specifically, the jet nozzles are shown in a side-to-side arrangement (FIG. 7a, illustrating jet nozzles 14a and 16a), a top/bottom arrangement (FIG. 7b, illustrating jet nozzles 14b and 16b), a diagonal arrangement (FIG. 7c, illustrating jet nozzles 14c and 16c) and a polygonal array (FIG. 7d, illustrating jet nozzles 14d, 15d, 16d and 17d). The present invention may also be used with concentric or coaxial jet nozzles, as shown, for example, in FIGS. 7e and 8b, illustrating an inner jet nozzle 14e and an outer jet nozzle 16e directed respective jet streams towards the plate 30. Regardless of the positioning and alignment of the jet nozzles, the precise positioning of the jet nozzles is coordinated with the respective flow rates for the fluids emitted from each jet nozzle so that optimal mixing of the fluids will occur when the fluids impinge the plate.

In the various jet nozzle positions and arrangements shown, and regardless of the number of jet nozzles used, the jet nozzle tips (e.g., 18 and 24) should be positioned so that the jet streams are directed towards the plate 30 for impingement and mixing. Upon impingement, each jet stream preferably creates an immediate high turbulence impact with the plate 30. When two jet nozzles are used (e.g., first and second jet nozzles 14 and 16 as shown in FIGS. 3 and 4), the jet nozzle tips are preferably arranged so that they direct a jet stream towards a pre-determined impact area, generally designated as reference numeral 44. Ideally, the respective jet streams intersect one another simultaneously with impinging the impact area 44. This design is easier to align than the known opposed impinging jet design. Adjusting the point of intersection of the respective jet streams requires only a two-dimensional adjustment because the impact area is pre-defined in one dimension by the position of the plate 30. In the opposed impinging jet design, the impact area requires a three-dimensional adjustment because the impact area is defined in a three-dimensional space which the two jet streams must precisely intersect to achieve micromixing. Unlike the precise opposed impinging jet design, the jet streams of the present invention need not intersect at the point of impact. While such simultaneous intersection is optimal, a degree of misalignment is acceptable provided the flow rates of the jet streams cause the fluids to spread on the impinging plate 30 into liquid films after impingement so that mixing will still occur between the liquid films without compromising the homogeneity of the mixture.

Accordingly, the positions and alignment of the jet nozzles 14 and 16 of the present invention, and their respective nozzles 18 and 24, are preferably angularly adjustable. Angular adjustments of the jet nozzles 14 and 16 typically depend upon the distance between the jet nozzle tips 18 and 24 and the plate 30, the distance between the jet nozzle tips 18 and 24, as well as the flow rates of the jet streams emitted from the jet nozzles 14 and 16. In FIGS. 3 and 4, the angular positions of the jet nozzles 14 and 16 are exaggerated for illustration of the impact area 44. Typically, the jet nozzles 14 and 16 are closer to parallel than acutely angled, with their nozzle tips 18 and 24 directed to face the surface of the plate 24—i.e., the two jet nozzle tips are almost normal to the impact area 44 from a bottom view (FIG. 4), depending on the distance of the jet nozzles 14 and 16 from the plate 30.

In a preferred embodiment, the jet nozzle tips 18 and 24 are approximately 3-5 cm. from the plate 30 and approximately 1 cm. from each other. There usually is a slight convergence of the jet streams as they impinge the plate 30. Each jet nozzle 14 and 16 is inwardly angled towards each other approximately 10 degrees from the normal direction to the plate 30. Further, each jet nozzle tip 18 and 24 can have a slight downward angle from the horizontal of about 10 degrees to help the flowing material move down the plate 30 after impingement.

In operation, the fluids A and B impinge the plate 30 under conditions of temperature and pressure to permit mixing, nucleation and precipitation of the fluids, and, where applicable, reaction of reactive intermediates included in the fluids, followed by nucleation and precipitation to produce a crystallized pharmaceutical product. Preferably, the fluids A and B spread over the surface of the plate 30 after impingement, and essentially form liquid films on the surface. The liquid films of the respective fluids A and B mix homogeneously. Where appropriate, the mixing of the liquid films causes reactive intermediates in the fluids to react, or an anti-solvent in one liquid film to interact with a feed solution in the other liquid film, prior to nucleation.

After mixing, reaction or other interaction, the mixture nucleates and precipitates to form crystal particles that fall from the plate 30 into the bottom of chamber 12 for further processing and/or filtration downstream.

The fluids A and B used in the present invention are preferably solvents that are miscible. The fluids A and B may comprise solutions in respective solvents of reactive intermediates. Alternatively, the first fluid A may comprise a feed solution containing an active pharmaceutical ingredient, while the second fluid B may contain an appropriate anti-solvent to effect a non-reactive mode of mixing and nucleation. Further, the fluids A and B may be identical, provided that the ultimate product has limited solubility in a common solvent. Usually, the first and second fluids A and B are not identical, the first fluid A, for example, being adapted to dissolve one reactive intermediate and the second fluid B being adapted to dissolve a second reactive intermediate. At least one of the solvents should be an “anti-solvent” which is chosen for its relatively low solvation properties with respect to the product. Although this invention is exemplary for preparing and crystallizing pharmaceutical salts, it will be obvious to those skilled in this art that the process described herein is applicable to prepare many types of small molecules with controlled particle size. The process is particularly useful for single step reactions, which proceed at a high rate under moderate conditions, for example, salt-formations including hydrates, free-basing and nucleophilic reactions. The process is also applicable to non-reactive anti-solvent precipitations, as described in U.S. Pat. No. 5,314,506. Various fluids or solutions that may be used in the present invention include, but are not limited to, water, tetrahydrofuran, methanol, acetone, ethanol, toluene, acetic acid and isopropyl alcohol.

In certain cases, as mentioned above, the first and second fluids A and B can be identical solvents. This applies when the first and second fluids A and B include respective first and second reactive intermediates that are soluble in a common solvent but whose reaction product or resulting salt form is highly insoluble in the solvent. In this case, the solvent acts as both the solvent and the anti-solvent for the reactive crystallization process. In another case, the reaction product may simply be a hydrated form of the active pharmaceutical ingredient.

For the convenience of illustration, the impinging plate 30 and 30a, as shown in FIGS. 4 and 9a, is circular and flat. However, the plate 30 is not limited to the precise shape shown, and accordingly the plate 30 may have a variety of shapes, sizes and designs, such as those illustrated in FIGS. 9a-9j. For example, the plate may be concave (FIGS. 9b and 9c, respectively illustrating plates 30b and 30c in vertical cross-section, and FIG. 9f, illustrating plate 30f in horizontal cross section) or convex (FIGS. 9d and 9e, respectively illustrating plates 30d and 30e in vertical cross-section, and FIG. 9g, illustrating plate 30g in horizontal cross section) to improve the mixing of the jet streams after they impinge the plates surfaces, as well as to reduce the splatter of the impinging fluids. The curvature of a concave or convex plate may be symmetrical about any axis, or radially symmetrical about the desired impact area 44 (e.g., lens-shaped plate 30h, as illustrated in FIG. 9h), or asymmetrical. Further, the plate can be any polygonal or irregular shape, as shown, for example, in FIGS. 9i and 9j (illustrating respective plates 30i and 30j).

In general, the plate 30 should facilitate the creation of a liquid film thereon when the jet streams impinge the impact area 44. A concave design is especially useful if the impingement points for the respective jet streams are misaligned. The curvature of the plate (e.g., plate 30b), or angles on the surfaces of the plate, can act to direct the respective films towards each other for mixing. The curvature, be it concave or convex, may also be useful in directing the mixed and nucleated final product away from the plate and into the chamber. The design of the plate 30 is generally dictated by the number of jet streams impinging the plate, the flow rates for the jet streams, the arrangement of the jet nozzle tips with respect to the plate (i.e., side-by-side, top/bottom, diagonal, etc.), the distance the jet nozzle tips are positioned from the plate, the distance between the jet nozzle tips, and the angle of the jet nozzle tips with respect to one another.

Additionally, a shield or shroud 46 may be provided around the upper and side portions of the plate 30, especially if the plate 30 is flat, to direct the mixed film towards the bottom of the chamber 12. The shield 46 also deflects splatter towards the center portion of the plate 30, and thus reduces contamination of the support members 38, 40 and 42 and the feed lines 22 and 28 positioned around the plate 30. Gravity also acts to feed the mixture off of the plate 30 and into the chamber 12. The plate 30 may also be provided with a coating (e.g., Teflon) or polished with a glass, diamond, or ceramic to aid in spreading the film over the surface of the plate so that the fluids will mix, and aid in dispersion of the mixture off the plate and into the chamber 12, as well as to prevent encrustation on the plate. Many of the materials used for and on the plate 30 are selected based on the composition of the fluids being emitted from the jet nozzles.

The impinging plate assembly 10 may be positioned within the chamber 12 at a variety of angles. In the embodiment shown in FIGS. 1-4, the assembly 10 has a vertical orientation. However, an impinging plate assembly 50 may be arranged in a chamber 52 in a horizontal orientation, as shown in FIG. 5. In the horizontal orientation, an impinging plate 54 is positioned horizontally within the chamber 52, and first and second jet nozzles 56 and 58 preferably direct jet streams from above the plate 54. The assembly may be mounted within the chamber 52 through a side wall of the chamber, as shown, with the horizontal support member 38 of FIG. 2 becoming a vertical support member 60. Similarly, horizontal support for the plate 54 is provided by support member 62, acting essentially in the same manner as vertical support member 40 of FIG. 2.

Alternatively, an impinging plate assembly 70 may be mounted within a chamber 72 through the top of the chamber 72 similar to the embodiment shown in FIGS. 1 and 2. In the embodiment shown in FIG. 6, an impinging plate 74 could be angled and, though not shown, held by a vertical support member 76 so as to be horizontally disposed within the chamber 72. The vertical support member 76 may be designed so as to permit a variety of angular positions for the plate 74. Similarly, first and second feed lines 78 and 80 for respective first and second jet nozzles 82 and 84, would ideally permit adjustment of the vertical angle of the jet nozzles 82 and 84, in addition to the horizontal angular adjustment discussed above. FIG. 6 shows an alternative embodiment of the present invention where the angle of the plate 74 has been adjusted so that the plate 74 faces downward at a 45 degree angle from the vertical. The jet nozzles 82 and 84 are positioned within the chamber 72 in a similar manner as to the embodiment of FIG. 2, except the jet nozzles 82 and 84 have been vertically angularly adjusted so as to be perpendicular to the desired point of impact on the plate 72.

The size and shape of an impinging plate in a horizontal orientation will usually be smaller than in other embodiments because the mixed film will need to flow over the edges of the plate into the chamber below. Nevertheless, properly controlled flow rates will aid in the dispersion of the mixed film over the edges of the plate so that the present invention is still operational in the horizontal orientation. Regardless of the orientation of the impinging jet assembly as used in the present invention, the jet nozzles should preferably be arranged so that the direction of the jet streams is essentially perpendicular to the orientation of the plate, and more preferably to the desired point of impact.

Unlike the opposed impinging jet method, the present invention may be used with concentric or converging jet nozzles. The use of an impinging plate for impingement and mixing permits a greater variance of turbulence so that the required micromixing can be achieved. As discussed with respect to FIG. 1, the first jet nozzle 14 is used to transport the first fluid A from an external supply source 20 into the chamber 12, and the second jet nozzle 16 is used to similarly transport the second fluid B from a second external supply source 26. The external supply sources 20 and 26 typically ensure that jet streams are emitted from the respective jet nozzle tips 18 and 24, and permit control of the velocity of the jet stream emanating from each nozzle. Each jet nozzle tip 18 and 24 is also provided with a fixed, inner diameter so that the jet stream emitted therefrom is fully developed and consistent. A controller (not shown in FIG. 1) can also be used to control the supply of fluids A and B, adjust the temperature inside the chamber 12 or of the surface of the plate 30, and monitor the product collected in the chamber 12.

The distance between the tips of the nozzles 18 and 24 and the plate 30 within the chamber 12 should be such that the hydrodynamic form of each jet stream remains essentially intact up to the point of impingement. Therefore, the maximum distance between the nozzle tips 18 and 24 and the plate 30 can vary depending on the flow rates and linear velocity of the fluids A and B emitted from the jet nozzle tips 18 and 24. To obtain good results for generally nonviscous fluids, linear velocity in the jet nozzle tips should be at least about 5 meters/sec., more preferably above 10 meters/sec., and most preferably between about 20 to 25 meters/sec., although the upper limit of linear velocity is only limited by the practical difficulties involved in achieving it. Linear velocity and flow rate can both be controlled by various known methods, such as altering the diameter of the entry tube and/or that of the nozzle outlet, and/or varying the strength of the external force that moves the fluid into and through the nozzle.

Each jet stream can be manipulated independently to attain a desired final fluid composition ratio. The flow rate of the jet streams may be adjusted by altering the sizing and diameter of the jet nozzles. However, the present invention is not as constrained as the opposed impinging jet design with respect to the respective final fluid composition ratios at the impingement point. Typically, the residence time for the impinging fluids inside the chamber is very short, i.e., less than ten seconds. Thus, in the opposed impinging jet design, the momentum of the respective jet streams must be equal. The impinging plate of the present invention provides greater leeway with respect to the fluid flow rates and momentum because of the formation of liquid films on the surface of the plate to aid in mixing of the fluids.

An ultrasonic generator 48 may also be used with the crystal production system of the present invention to subject the mixed fluids to ultrasonic energy and promote the production of small crystal particles. The use of the ultrasonic generator 48 along with the impinging plate assembly 10 also aids in achieving high intensity micromixing in a continuous process. In such a situation, the ultrasonic generator 48 is preferably positioned outside the chamber 12 and away from the mixing point of the fluids in the impinging plate assembly 10. The ultrasonic generator 48 preferably is mounted outside the chamber 12 and communicates with the impinging plate assembly 10 to transfer ultrasonic energy to the impinging plate 30. As shown in FIGS. 1-3, the ultrasonic generator 48 is attached to the vertical support member 40 and transfers ultrasonic energy to the impinging plate 30 by way of the vertical support member 40. Preferably, the vertical support member 40 and the impinging plate 30 are constructed from materials that assist in the transfer of the ultrasonic energy generated by the ultrasonic generator 48.

The foregoing description of embodiments of the present invention has been presented for the purpose of illustration and description, and is not intended to be exhaustive or to limit the present invention to the form disclosed. As will be recognized by those skilled in the pertinent art to which the present invention pertains, numerous changes and modifications may be made to the above-described embodiments without departing from the broader aspects of the present invention.

What is claimed is:

1. A crystal production apparatus comprising:
an impinging plate having an impact area defined on a surface thereof; and
at least two jet nozzles adapted to direct respective jet streams towards the impinging plate so that said jet streams impinge the impact area of the impinging plate.

2. A process for synthesis and crystallization of a pharmaceutical product having small crystals of controlled particle size, comprising the steps of:
impinging at least one jet stream of a first fluid on an impact area defined on a surface of an impinging plate;
impinging at least one jet stream of a second fluid on the impact area; and
mixing the at least one jet stream of the first fluid with the at least one jet stream of the second fluid about the vicinity of the impact area upon impingement of the jet streams with the impinging plate, each jet stream having sufficient linear velocity to achieve high intensity mixing of said fluids, followed by nucleation of the pharmaceutical product.

3. A process for synthesis and crystallization of a pharmaceutical product having small crystals of controlled particle size, comprising the steps of:
impinging at least one jet stream of a first fluid including a first reactive intermediate on an impact area defined on a surface of an impinging plate;
impinging at least one jet stream of a second fluid including a second reactive intermediate on the impact area;
mixing the at least one jet stream of the first fluid with the at least one jet stream of the second fluid about the vicinity of the impact area upon impingement of the jet streams with the impinging plate, each jet stream having sufficient linear velocity to achieve high intensity mixing of said fluids;
reacting the first and second reactive intermediates, followed by nucleation of the pharmaceutical product.

4. A process for synthesis and crystallization of a pharmaceutical product having small crystals of controlled particle size, comprising the steps of:
impinging at least one jet stream of a first fluid including a feed solution of the pharmaceutical product on an impact area defined on a surface of an impinging plate;
impinging at least one jet stream of a second fluid including an anti-solvent on the impact area; and
mixing the at least one jet stream of the first fluid with the at least one jet stream of the second fluid about the vicinity of the impact area upon impingement of the jet streams with the impinging plate, each jet stream having sufficient linear velocity to achieve high intensity mixing of the feed solution and the anti-solvent, followed by nucleation of the pharmaceutical product.

5. A process according to any one of claims 2 to 4, wherein the pharmaceutical product is voriconazole.
